(19) United States
(12) Patent Application Publication
(10) Pub. No.: US 2003/0008033 A1
(43) Pub. Date: Jan. 9, 2003

(54) Spring plunger with positioning function

(76) Inventor: Koichiro Takai, Mino-shi (JP)

Correspondence Address: SHLESINGER, ARKWRIGHT & GARVEY LLP, 3000 South Eads Street, Arlington, VA, 22202, US

(21) Appl. No.: 10/170,678

(22) Filed: Jun. 14, 2002

(30) Foreign Application Priority Data
Jul. 6, 2001 (JP) 2001-244983

(51) Int. Cl. B29C 33/44

(52) U.S. Cl. 425/443; 425/441

(57) ABSTRACT

The spring plunger of the present invention comprises: a body; a stopping portion for stopping the body; a pin whose projection height from the surface of a plate is to be precisely decided; a spring connected with the pin, and spring stopper for fig the end of the spring. When the stopping portion contacts a pit surface provided on the surface of the plate, the body of the spring plunger does not proceed any more in the female screw in the plate. Thus, the pin projection height from the surface of the plate is kept constant. According to the present invention, the pin projection height from a surface of an object body such as a mold surface can be controlled easily and precisely.

### BACKGROUND OF THE INVENTION

1. Field of the Invention

The present invention relates to a spring plunger with positioning function, wherein a projection height of a pin of the plunger from a surface of an object plane such as a plate can be maintained to be a constant value.

2. Description of the Prior Art

The projection height of a pin of a conventional spring plunger from a surface such as a plate surface is determined merely by a distance screwed into the plate by a screw portion tapped on the plunger surface.

However, the conventional spring plunger has a disadvantage that the pin projection height can not be determined precisely.

### SUMMARY OF THE INVENTION

An object of the present invention is to determine precisely the projection height 5 of the pin 3 connected with the spring 6 in the body 1 of a spring plunger. The spring plunger of the present invention includes: the stopping portion 2 which can not be screwed in a female screw of an object such as the plate 4. Here, the stopping portion 2 is bigger than a valley diameter of the female screw of the plate 4. The stopping portion 2 as shown in FIG. 1 is formed, for example, by mechanical machining.

According to the present invention, the pin projection height from a surface of an object body such as a mold surface can be controlled easily and precisely.

### BRIEF EXPLANATION OF THE DRAWINGS

FIG. 1 is a cross sectional view of the spring plunger of the present invention screwed in a female screw of an object.

FIG. 2A is a plan view of a pin of the spring plunger of the present invention.

FIG. 2B is a cross sectional vies of the spring plunger of the present invention.

FIG. 2C is a plan view of a spring stopper of the spring plunger of the present invention.

### PREFERRED EMBODIMENT OF THE INVENTION

Preferred embodiment of the present invention is explained, referring to the drawings.

The spring plunger of the present invention comprises: the body 1; the stopping portion 2 for preventing the body 1 from proceeding further into the object body such as the plate 4; the pin 3 whose the projection height 5 from the surface of the plate 4 is to be fixed precisely at a predetermined value; the spring 6 connected with the pin 3; and the spring stopper 7 for supporting the end of the spring 6.

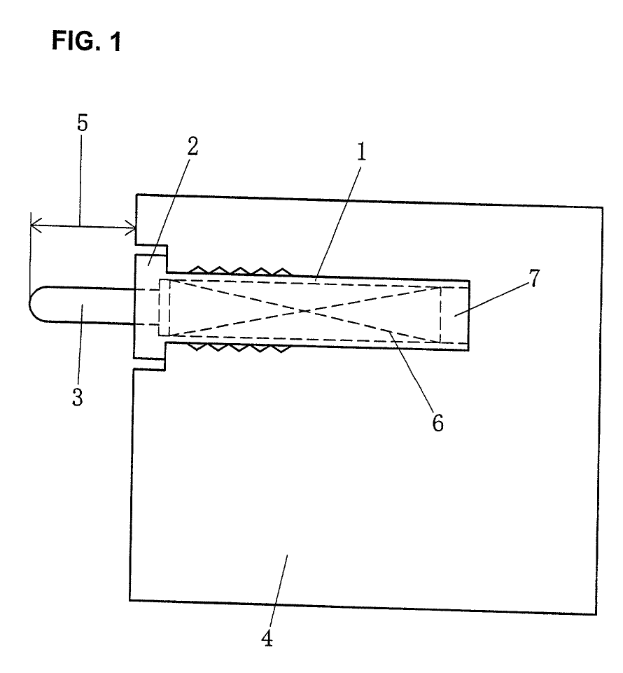

When the stopping portion 2 contacts a pit surface as shown in FIG. 1 provided on the surface of the plate 4, the body 1 can not proceed any more in the female screw in the plate 4.

Here, the pit is not necessarily required on the surface of plate 4. Further, the plate 4 may be a part of a three dimensional object body.

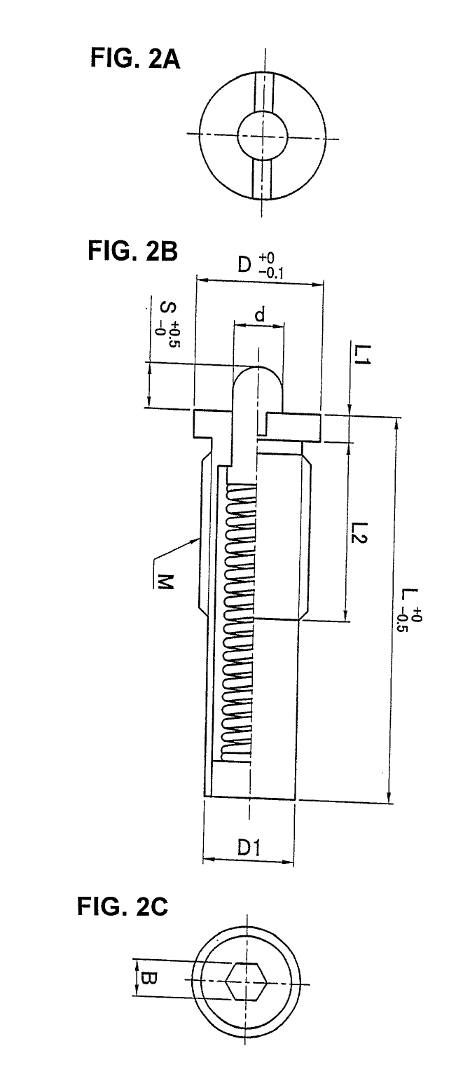

An exemplary spring plunger is shown in FIG. 2A, 2B and 2C.

One end of the body 1 as shown in FIG. 2B having male screw portion M is connected with a free end of the pin 3 surrounded by the stopping portion 2 as shown in FIG. 2A. The thickness of the stopping portion is L1. The stopping portion 2 may be screwed in the body 1, as shown in FIGS. 2A and 2B. The other end of the spring 6 is supported by the spring stopper 7 screwed in by a screw not-shown in FIG. 2C.

The spring plunger of the present invention is utilized, for example, in connection with a mold. A plurality of the spring plungers of the present invention are screwed in each mold of a pair of the molds, thereby easily separating the pair of molds by the spring forces, after completing molding a three dimensional body such as a three dimensional plastic body. When one of the pins of the screwed-in plungers is troubled after repeating molding, the troubled plungers is swapped by a new one, without deviating the prescribed pin projection height. Thus, the costly mold can be repeatedly used under the same separation condition.

What is claimed is:

1. A spring plunger, which comprises:
a body whose outer surface is tapped partly;
a spring accommodated in said body and fixed at a bottom of said body;
a pin connected with said spring at a free end of said spring; and
a stopping portion fixed or formed at an edge of said body for passing said pin,
wherein said stopping portion is bigger than a thread diameter of a male screw of said body whose outer surface is tapped partly.

2. The spring plunger according to claim 1, wherein said spring plunger is screwed in a female screw of an object body and said stopping portion is stopped at a surface of said object body.

3. The spring plunger according to claim 2, wherein said object body is a mold.
